(19) United States
(12) Patent Application Publication
(10) Pub. No.: US 2012/0317232 A1
(43) Pub. Date: Dec. 13, 2012

(54) SERVICE PROCESSING METHOD, METHOD AND SERVICE NODE FOR ADJUSTING DELIVERED CONTENT

(75) Inventor: Hongqiang BAO, Shanghai (CN)

(73) Assignee: HUAWEI TECHNOLOGIES CO., LTD., Shenzhen (CN)

(21) Appl. No.: 13/591,747

(22) Filed: Aug. 22, 2012

Related U.S. Application Data
(63) Continuation of application No. PCT/CN2011/074971, filed on May 31, 2011.

(30) Foreign Application Priority Data
Sep. 15, 2010 (CN) 201010285667.2

(51) Int. Cl. G06F 15/16

(52) U.S. Cl. 709/217

(57) ABSTRACT

A service processing method, a method for adjusting delivered content, and a service node are provided in embodiments of the present invention. The service processing method includes: receiving, by a first service node, a service scheduling request sent by a terminal, wherein the first service node is any one service node except a central node on a content delivery network (CDN); determining, by the first service node, an available service node according to indication information that is sent by a control node and indicates an upper/lower-level relationship of the first service node on the CDN and according to content requested by the terminal; and providing, by the available service node, the requested content to the terminal. The technical solutions provided in the embodiments of the present invention help reduce the service processing load of the central node and make service processing more flexible.

### CROSS-REFERENCE TO RELATED APPLICATIONS

This application is a continuation of International Application No. PCT/CN2011/074971, filed on May 31, 2011, which claims priority to Chinese Patent Application No. 201010285667.2, filed on Sep. 15, 2010, both of which are hereby incorporated by reference in their entireties

### FIELD OF THE INVENTION

The present invention relates to the communications technology field, and in particular, to a service processing method, and a method and a service node for adjusting delivered content.

### BACKGROUND OF THE INVENTION

Currently, applications of a video service on an IP network grow continuously. Because the video service has features such as a large bandwidth to be occupied and a high real time requirement, directly bearing a video service on an existing basic IP network brings a series of problems such as traffic congestion and degraded quality of service (Quality of Service, QoS).

To solve the preceding problems, content delivery network (Content Delivery Network, CDN) technology has drawn wide attention and been widely used. A basic function of a CDN is to push video content to an edge node of a network, thereby allowing timely response to a demand of a terminal for watching video content. A CDN is a network between a basic bearer network and various service applications, and is formed by a multi-layer architecture. CDN devices deployed at different layers are normally called nodes (Node, PoP, Cluster). According to different positions on the CDN, nodes may be classified into a central node (Central Node), a backbone node (backbone Node), and an edge node (Edge Node). Generally, many function modules, for example, a central management module that is configured to manage each node on the CDN, a media management module that is configured to manage delivery of media content, a content interface that is configured to forward a received service scheduling request of a terminal to a request scheduling module of a corresponding backbone node and receive content sent by an external content source, and a flow service module that is configured to directly send content requested in the service scheduling request to the terminal, are deployed on the central node. A media management module that is configured to manage delivery of media content, a request scheduling module that is configured to forward a received service scheduling request of a terminal to a corresponding edge node, and a flow service module that is configured to directly send content requested in the service scheduling request to the terminal are deployed on the backbone node. Only a flow service module is deployed on the edge node.

In the prior art, a processing procedure for a service scheduling request of a terminal is: After the central node receives a service scheduling request sent by the terminal, when the request scheduling module determines, according to information about each node managed by the central management module, that a distance from a certain backbone node to the terminal is shorter than a distance from the central node to the terminal, the central node sends the service scheduling request to the backbone node; and after receiving the service scheduling request, a request scheduling module in the backbone node delivers the service scheduling request to an edge node that owns content requested by the terminal and is near the terminal, and the edge node sends a service requested by the service scheduling request to the terminal.

On the CDN according to the prior art, only the central node is able to receive a service scheduling request from a terminal, and forward it to a backbone node, and then the backbone node forwards it to an edge node. As a result, existing service processing is not flexible, and a processing load of the central node is large.

### SUMMARY OF THE INVENTION

Embodiments of the present invention provide a service processing method, and a method and a service node for adjusting delivered content, so that a service processing load of a central node can be reduced and service processing is made more flexible.

In light of this, embodiments of the present invention provide:

a service processing method, including:

receiving, by a first service node, a service scheduling request sent by a terminal, where the first service node is any one service node except a central node on a content delivery network;

determining, by the first service node, an available service node according to indication information that is sent by a control node and indicates an upper/lower-level relationship of the first service node on the content delivery network CDN and according to content requested by the terminal; and

providing, by the available service node, the requested content for the terminal.

a method for adjusting delivered content, including:

receiving a service scheduling request sent by a terminal, where the service scheduling request carries an identity of content requested by the terminal, and records times of service scheduling requests for the content requested by the terminal; determining a current heat value of the content requested by the terminal according to an initial heat value of the content requested by the terminal and the times of service scheduling requests for the content; and

delivering the content to a lower-level service node that does not own the content when the current heat value of the content requested by the terminal reaches a heat threshold and the lower-level service node that does not own the content exists among lower-level service nodes of the first service node.

a service node, where the service node is any one service node except a central node on a content delivery network, and the service node includes:

a receiving unit, configured to receive a service scheduling request sent by a terminal; and

a determining unit, configured to determine an available service node according to indication information that is sent by a control node and indicates an upper/lower-level relationship of the service node on the CDN and according to content requested by the terminal; where the available service node is configured to provide the requested content for the terminal.

a service node, including:

a receiving unit, configured to receive a service scheduling request sent by a terminal, where the service scheduling request carries an identity of content requested by the terminal, and records times of service scheduling requests for the content requested by the terminal;

a determining unit, configured to determine a current heat value of the content requested by the terminal according to an initial heat value of the content requested by the terminal and the times of service scheduling requests for the content; and

a content delivering unit, configured to deliver the content to a lower-level service node that does not own the content when the current heat value of the content requested by the terminal reaches a heat threshold and the lower-level service node that does not own the content exists among lower-level service nodes of the first service node. Any one service node except the central node provided in this embodiment is able to directly receive the service scheduling request sent by the terminal, and determine an available service node according to the indication information that is sent by the control node and indicates an upper/lower-level relationship of the service node on the CDN and according to content requested by the terminal. Therefore, a specific service node (that is, central node in the prior art) does not need to process all service scheduling requests of all terminals, reducing the service processing load of the central node and making service processing more flexible.

### BRIEF DESCRIPTION OF THE DRAWINGS

To describe the technical solutions in the embodiments of the present invention more clearly, the accompanying drawings for illustrating the embodiments are briefly introduced in the following. Apparently, the accompanying drawings in the following description are only some embodiments of the present invention, and persons skilled in the art may derive other accompanying drawings from these accompanying drawings without creative efforts.

FIG. 1 is a flow chart of a service processing method according to an embodiment of the present invention;

FIGS. 2A1 and 2A2 are flow charts of a method for determining an available service node according to an embodiment of the present invention;

FIGS. 2B1 and 2B2 are flow charts of another method for determining an available service node according to an embodiment of the present invention;

FIG. 3A is a flow chart of a processing method in which a service node that has a lower-level service node on a CDN receives a service scheduling request according to an embodiment of the present invention;

FIG. 3B is a flow chart of a processing method in which a service node that has no lower-level service node on a CDN receives a service scheduling request according to an embodiment of the present invention;

FIG. 4 is a flow chart of adjusting delivered content according to an embodiment of the present invention;

FIG. 5A is a structural diagram of a service node according to an embodiment of the present invention;

FIG. 5B is a structural diagram of another service node according to an embodiment of the present invention;

FIG. 6 is a structural diagram of a CDN according to an embodiment of the present invention; and

FIG. 7 is a structural diagram of a CDN after a structure of the CDN provided in FIG. 7 is adjusted according to another embodiment of the present invention.

### DETAILED DESCRIPTION OF THE EMBODIMENTS

The technical solutions in the embodiments of the present invention are described clearly and completely in the following with reference to the accompanying drawings in the embodiments of the present invention. Apparently, the embodiments to be described are only a part rather than all of the embodiments of the present invention. Based on the embodiments of the present invention, all other embodiments obtained by persons skilled in the art without making creative efforts shall fall within the protection scope of the present invention.

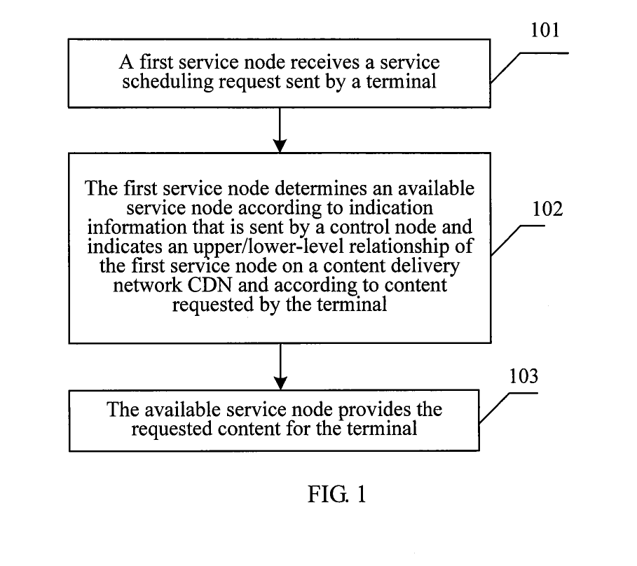

As shown in FIG. 1, an embodiment of the present invention provides a service processing method, including the following:

101: A first service node receives a service scheduling request sent by a terminal.

The service node may be any one service node except a central node on a CDN.

102: The first service node determines an available service node according to indication information that is sent by a control node and indicates an upper/lower-level relationship of the first service node and according to content requested by the terminal.

The indication information that indicates the upper/lower-level relationship of the first service node on the CDN is sent by the control node to the first service node, and the indication information that indicates the upper/lower-level relationship of the first service node includes: an identity of the first service node, an identity of a service node that is connected to the first service node, and an indication that indicates a relationship between the first service node and a service node to which the first service node is connected. For example, it is assumed that a certain service node to which the first service node is connected is an upper-level service node of the first service node. Then bits 00 are added at the end of the identity of the service node. If a certain service node to which the first service node is connected is a lower-level service node of the first service node, bits 11 are added at the end of the identity of the service node. In this way, the first service node can know, according to whether bits at the end of the identity of the service node are 00 or 11, whether the service node is an upper-level service node or lower-level service node of the first service node. Or, the indication information that indicates the upper/lower-level relationship of the first service node includes: an identity and a number of the first service node, and an identity and a number of a service node connected to the first service node. For example, a network side specifies in a unified manner that a first digit of a number of a service node (a first-level service node for short) directly connected to the control node is 1, a first digit of a number of a lower-level service node (a second-level service node for short) of the first-level service node is 2, a first digit of a number of a lower-level service node (a third-level service node for short) of the second-level node is 3, and the rest is deduced through analogy. In this way, after receiving the indication information that indicates the upper/lower-level relationship, the first service node knows, according to its number and the number of the service node to which the first service node is connected, whether the service node is its upper-level service node or lower-level service node.

Specifically, during initial CDN configuration, the control node sends position information of each service node on the CDN to a corresponding service node. The position information includes: indication information that indicates an upper/lower-level relationship between service nodes on the CDN. Subsequently, if a position of any one service node is adjusted, the control node will receive specified new position information of the service node on the CDN, where the new position information includes an indication that indicates an upper/lower-level relationship between the service node and other service nodes, and then the control node sends the new position information to the service node whose position is adjusted. If any one service node is deleted, the control node receives a specified command for deleting the any one service node. When the service node has upper-level service nodes, the indication that indicates an upper/lower-level relationship between the service node and the upper-level service nodes is deleted, and then new position information is sent to the upper-level service node, where the new position information does not include the indication that indicates the upper/lower-level relationship between the deleted service node and the upper-level service node.

For a specific implementation process of step 102, reference may be made to a detailed description in subsequent embodiments.

103: The available service node provides the requested content for the terminal.

Any one service node provided in this embodiment is able to directly receive the service scheduling request sent by a terminal, and determine an available service node according to indication information that is sent by a control node and indicates an upper/lower-level relationship of the service node on a CDN and according to content requested by the terminal. Therefore, one service node (that is, a central node in the prior art) does not need to process all service scheduling requests of all terminals, thereby reducing a service processing load of the central node and making service processing more flexible.

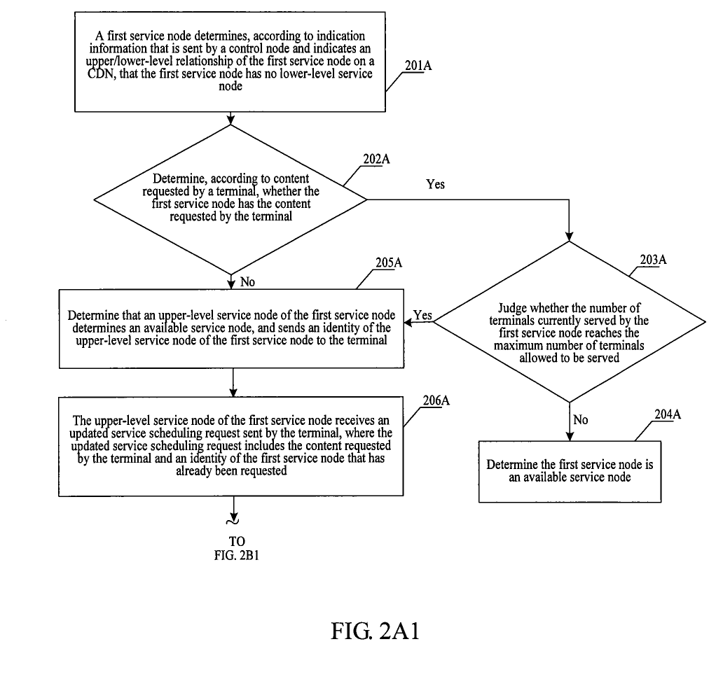

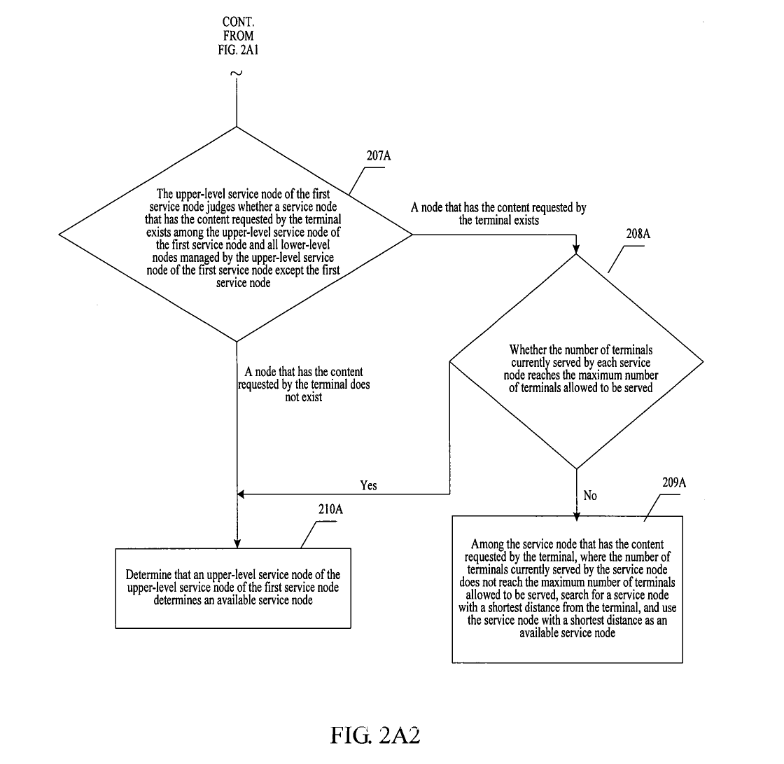

Referring to FIGS. 2A1 and 2A2, a specific process of step 102 includes:

201A: A first service node determines, according to indication information that is sent by a control node and indicates an upper/lower-level relationship of the first service node on a CDN, that the first service node has no lower-level service node.

202A: The first service node determines, according to content requested by a terminal, whether the first service node has the content requested by the terminal; if yes, go to step 203A; if no, go to step 205A.

203A: Judge whether the number of terminals currently served by the first service node reaches the maximum number of terminals allowed to be served; if yes, perform step 204A; if no, perform step 205A.

The maximum number of terminals allowed to be served may be the maximum number set for the same content, where the maximum number set for the same content is the maximum number of terminals allowed to be served, or may also be the maximum number set for all content, where the maximum number set for all content is the maximum number of terminals allowed to be served.

It should be noted that if no maximum number of terminals allowed to be served is set for the first service node, directly go to step 204A when a judgment result of step 202A is yes.

204A: The first service node determines that the first service node is an available service node.

205A: The first service node determines that an upper-level service node of the first service node is an available service node, and sends an identity of the upper-level service node of the first service node to the terminal.

206A: The upper-level service node of the first service node receives an updated service scheduling request sent by the terminal, where the updated service scheduling request includes the content requested by the terminal and the identity of the first service node that has already been requested.

207A: The upper-level service node of the first service node determines that the updated service scheduling request includes the identity of the first service node, and judges whether service nodes that own the content requested by the terminal exist among the upper-level service node of the first service node and all lower-level nodes managed by it except the first service node; if yes, perform step 208A; if no, perform step 210A.

208A: The upper-level service node of the first service node determines service nodes that own the content requested by the terminal among the upper-level service node of the first service node and all subordinate nodes except the first service node, and judges whether the number of terminals currently served by each of the determined service nodes reaches the maximum number of terminals allowed to be served. When service nodes that own the content requested by the terminal exist, where the number of terminals currently served by the service nodes does not reach the maximum number of terminals allowed to be served, perform step 209A; and if service nodes that own the content requested by the terminal do not exist, where the number of terminals currently served by the service nodes does not reach the maximum number of terminals allowed to be served, perform step 210A.

209A: Among the service nodes that own the content requested by the terminal, where the number of terminals currently served by the service nodes does not reach the maximum number of terminals allowed to be served, search for a service node with a shortest distance from the terminal, and use the service node as an available service node.

210A: Determine that an upper-level service node of the upper-level service node of the first service node determines an available service node, until the available service node is determined, where a determining method is the same as that used by the upper-level service node of the first service node.

Alternatively, referring to FIGS. 2B1 and 2B2, a specific process of step 102 includes:

201B: A first service node determines, according to indication information that is sent by a control node and indicates an upper/lower-level relationship of the first service node on a CDN, that the first service node has a lower-level service node.

202B: The first service node judges whether service node that own the content requested by the terminal exist among the first service node and lower-level service nodes managed by it; if yes, perform 203B; if no, perform 205B.

203B: Judge whether the number of terminals currently served by each service node that has the content requested by the terminal reaches the maximum number of terminals allowed to be served. When service nodes that own the content requested by the terminal exist, where the number of terminals currently served by the service nodes does not reach the maximum number of terminals allowed to be served, perform step 204B; when service nodes that own the content requested by the terminal do not exist, where the number of terminals currently served by the service nodes does not reach the maximum number of terminals allowed to be served, perform step 205A.

204B: Among the service nodes that own the content requested by the terminal, where the number of terminals currently served by the service nodes does not reach the maximum number of terminals allowed to be served, select a service node with a shortest distance from the terminal as an available service node.

Steps 205B to 210B are similar to steps 205A to 210A, and are not described herein again.

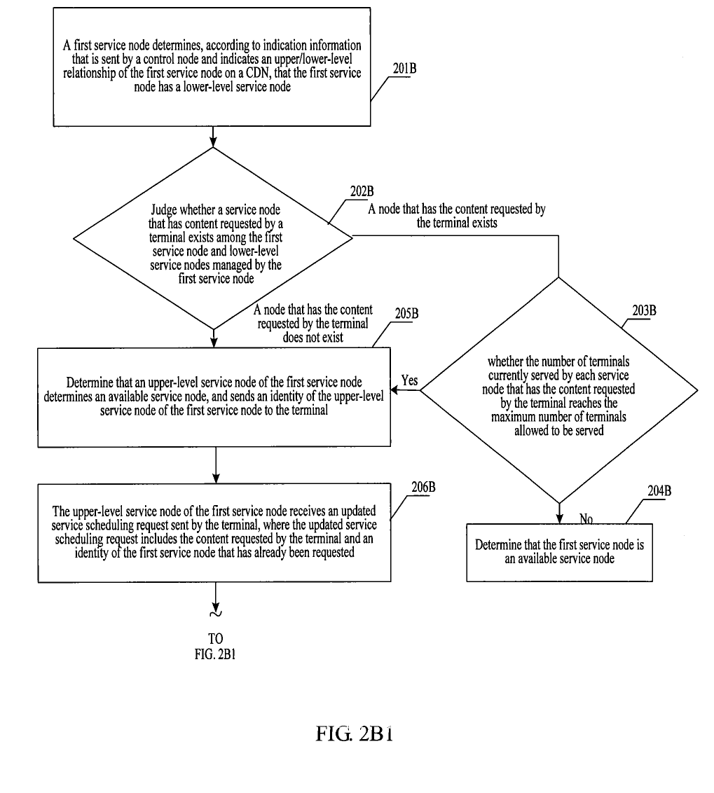

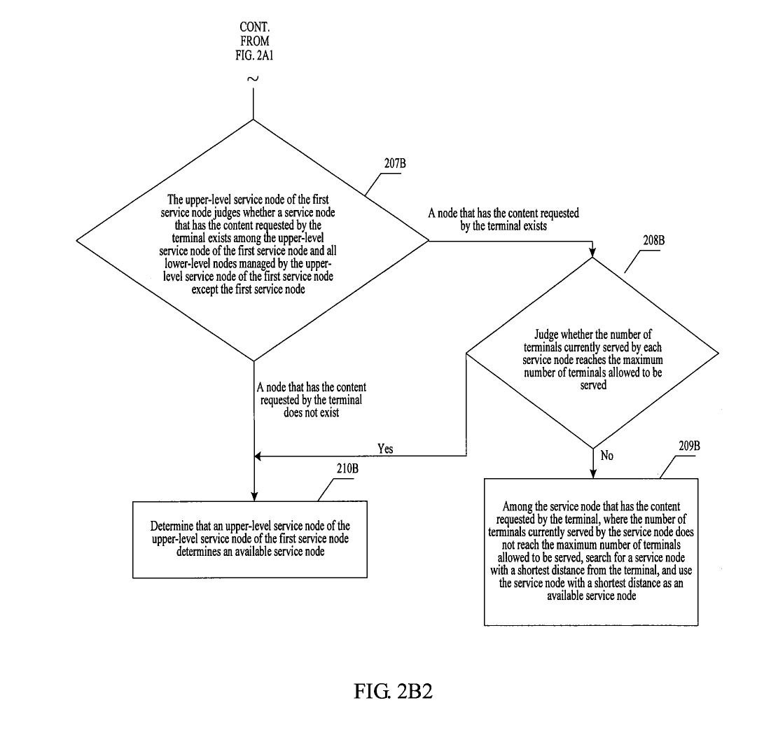

FIG. 3A shows a service scheduling response method according to an embodiment of the present invention. In this method, a processing method in which a service node (that is, a non-edge node) that has a lower-level service node on a CDN receives a service scheduling request is described. In this method, after receiving a service scheduling request, a non-edge node considers lists of content stored on lower-level service nodes and distances from them to a terminal, selects one lower-level service node, and redirects the service scheduling request to the selected service node. The method specifically includes:

301A: A terminal sends a service scheduling request to a first service node on a network, where the service scheduling request carries an ID of the service scheduling request and an identity of requested content.

302A: The first service node determines, according to indication information that indicates an upper/lower-level relationship of the first service node on a CDN, that the first service node has multiple lower-level service nodes, then determines, according to a distance from each lower-level service node to the terminal, that lower-level service node exist, where distances from the lower-level service nodes to the terminal are shorter than a distance from the first service node to the terminal, and selects one lower-level service node according to lists of content stored on these determined lower-level service nodes and distances from them to the terminal. The first service node sends a redirection indication to the terminal, where the redirection indication carries an identity of the selected lower-level service node.

It is assumed that the selected lower-level service node is a second service node. The first service node in this step records the ID of the service scheduling request and an identity of the selected second service node.

Specifically, the first service node in this step will determine first whether lower-level service nodes whose distances from the terminal are smaller than a distance from the first service node to the terminal; if yes, determines, according to lists of content stored on these lower-level service nodes, lower-level service nodes that have content requested by the terminal, and then selects, among the lower-level service nodes that have the content requested by the terminal, one lower-level service node with a shortest distance from the terminal.

In addition, the first service node further records a service capability, that is, the maximum number of terminals allowed to be served by each lower-level service node for the same content. Therefore, after determining the lower-level service nodes that have the content requested by the terminal, the first service node selects, according to distances from the lower-level service nodes that have the content requested by the terminal to the terminal and service capabilities, one lower-level service node, specifically, selects a service node with a shortest distance from the terminal among service nodes that have the content requested by the terminal, where the number of terminals currently served by the service nodes does not reach the maximum number of terminals allowed to be served.

303A: The terminal sends the service scheduling request to the second service node.

304A: The second service node determines, according to indication information that indicates an upper/lower-level relationship of the second service node on the CDN, that it does not have lower-level service nodes but that it is an edge node, and judges whether a number of terminals currently served by the second service node reaches the maximum number of terminals allowed to be served; if no, go to 305A; if yes, go to 306A.

This step assumes that the second service node has set a maximum number of terminals allowed to be served for a same piece of content. If the second service node does not set a maximum number of terminals allowed to be served for a same piece of content, the second service node directly sends content to the terminal.

305A: The second service node sends the content requested by the terminal to the terminal. This procedure ends.

306A: The second service node sends a redirection indication to the terminal, where the redirection indication carries an identity of an upper-level service node (that is, first service node) of the service node, so that the terminal requests content from the upper-level service node of the service node.

307A: The terminal will send an updated service scheduling request to the first service node, where the updated service scheduling request carries an identity of the second service node and an ID of the service scheduling request. After receiving the updated service scheduling request, the first service node determines a lower-level service node (that is, second service node) that has already been selected for the service scheduling request corresponding to the ID, selects a lower-level service node from other lower-level service nodes whose distances from the terminal are smaller than a distance from the first service node to the terminal except the lower-level service node that has already been selected. The first service node sends the redirection indication to the terminal, where the redirection indication carries an identity of the selected lower-level service node, so that the terminal requests service from the selected lower-level service node subsequently.

When executing step 302A and step 307A, the first service node may further only select a lower-level service node according to a distance from a lower-level service node to the terminal and send the redirection indication to the terminal without considering lists of content on the lower-level service nodes, where the redirection indication carries the identity of the selected lower-level service node, so that the terminal requests service from the selected lower-level service node subsequently.

It should be noted that if all lower-level service nodes whose distances from the terminal are smaller than the distance from the first service node to the terminal cannot provide service for the terminal, the first service judges whether it is able to provide service for the terminal. When the first service node has the content requested by the terminal, and a number of terminals currently served by the first service node does not reach the maximum number of terminals allowed to be served, the first service node is able to provide service for the terminal; when the first service node does not have the content requested by the terminal, or the number of terminals currently served by the first service node already reaches the maximum number of terminals allowed to be served, the first service node cannot provide service for the terminal, and the first service node sends a redirection indication to the terminal, where the redirection indication carries an identity of an upper-level service node of the first service node. Subsequently, the terminal requests the content from the upper-level service node of the first service node. The operations after the upper-level service node of the first service node receives the service scheduling request are similar to the operations after the first service node receives the service scheduling request, and are not described herein again.

Any one service node provided in this embodiment is able to directly receive the service scheduling request sent by the terminal, and determine an available service node according to the indication information that is sent by the control node and indicates an upper/lower-level relationship of the service node on the CDN and according to content requested by the terminal. Therefore, a service node (that is, central node in the prior art) does not need to process all service scheduling requests of all terminals, reducing the service processing load of the central node and making service processing more flexible.

FIG. 3B shows a service scheduling response method according to an embodiment of the present invention. This method describes a processing method after a service node that has no lower-level service node on the CDN receives a service scheduling request. The method includes the following:

301B: A terminal sends the service scheduling request to a first service node on a network, where the service scheduling request carries an ID of the service scheduling request and an identity of requested content.

302B: The first service node determines, according to indication information that indicates an upper/lower-level relationship of the first service node on the CDN, that it has no lower-level service node, and then judges whether it is able to provide service for the terminal; if yes, go to 303B; if no, go to 304B.

Specifically, judging whether it is able to provide service for the terminal includes: judging whether the content requested by the terminal exists locally; when the first service node is set with a maximum number of terminals allowed to be served, further judging whether a number of terminals currently served by the first service node reaches the maximum number of terminals allowed to be served; when the content requested by the terminal exists locally, and the number of terminals currently served by the first service node does not reach the maximum number of terminals allowed to be served, it indicates that the first service node is able to provide service for the terminal. When the content requested by the terminal does not exist locally, or the number of terminals currently served by the first service node reaches the maximum number of terminals allowed to be served, it indicates that the first service node cannot provide service for the terminal.

303B: The first service node sends the content requested by the terminal to the terminal. This flow ends.

304B: The first service node sends an identity of an upper-level service node so as to instruct the terminal to request service from the upper-level service node of the service node.

Subsequently, the upper-level service node of the first service node receives an updated service scheduling request sent by the terminal, where the updated service scheduling request includes the content requested by the terminal and identity of the first service node that has been requested. The upper-level service node of the first service node determines that the updated service scheduling request carries the identity of the first service node, determines a service node that owns the content requested by the terminal and has a smallest distance from the terminal among the upper-level service node of the first service node and all subordinate nodes managed by it except the first service node, and sends a redirection indication to the terminal, where the redirection indication carries an identity of the determined service node so that the terminal requests data from the service node.

Or, when the service node is set with a maximum number of terminals allowed to be served, determines a service node that owns the content requested by the terminal, whose number of currently served terminals does not reach the number of terminals allowed to be served, and that has a smallest distance from the terminal among the upper-level service node of the first service node and all subordinate nodes managed by it except the first service node, and sends a redirection indication to the terminal, where the redirection indication carries an identity of the determined service node so that the terminal requests data from the service node.

An edge node provided in this embodiment of the present invention can directly receive and respond to a service scheduling request sent by a terminal, thereby greatly improving the speed of responding to the service scheduling request of the terminal.

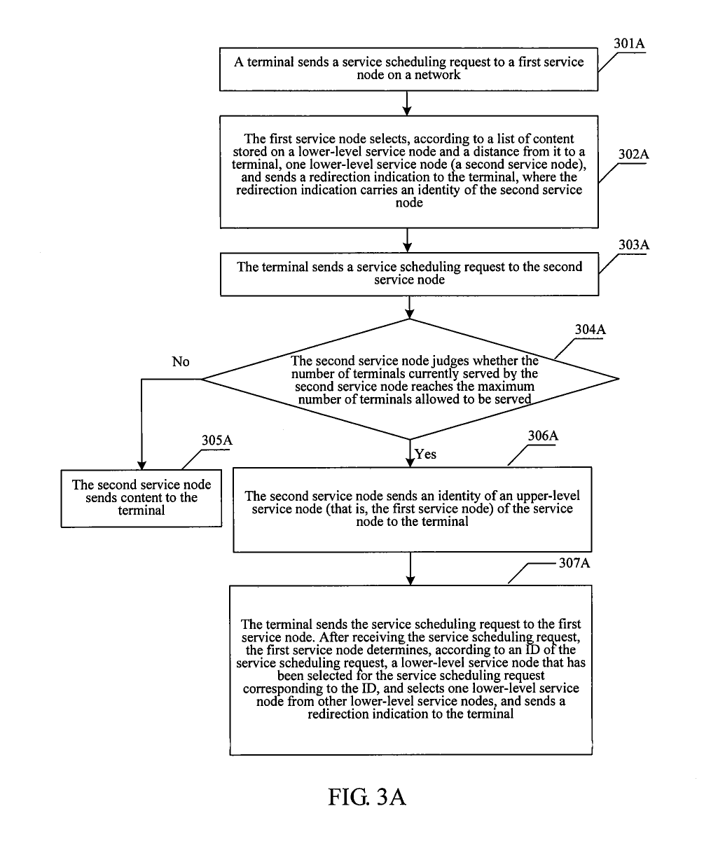

A content delivery method that uses a network structure in the present invention is the same as the content delivery method in the prior art, and is not described in detail herein. FIG. 4 shows a method for adjusting delivered content according to an embodiment of the present invention. The method specifically includes:

401: Receive a service scheduling request sent by a terminal, where the service scheduling request carries an identity of content requested by the terminal, and records times of service scheduling requests for the content requested by the terminal.

402: According to an initial heat value of the content requested by the terminal and the times of service scheduling requests for the content requested by the terminal, update a heat value of the content. The initial heat value of the content may be preset by a content supply source, or may also be obtained through negotiation between a content supply source and a control node. The heat value of the content may indicate a degree of popularity of the content among users.

The following describes how to update the heat value of the content by using an example.

When the heat value of the content is updated, a ratio of times of service scheduling requests for the content received in a current period to times of service scheduling requests for all content and a previous heat value of the content need to be considered. For example, the weight for the ratio of the times of the service scheduling requests for the content received in the current period to the times of the service scheduling requests for all content is 0.8, and the weight for the previous heat value of the content is 0.2. It is assumed that the ratio of the times of the service scheduling requests for the content received in the current period to the times of the service scheduling requests for all content is expressed by a, and the heat value of the content is expressed by Y:

Then, a heat value Yᵢ of the content in the current period is determined as follows:

Yᵢ=a×0.8+Yᵢ₋₁×0.2

where, is a heat value of the content in a previous period.

403: Deliver the content to a lower-level service node that does not own the content when the current heat value of the content requested by the terminal reaches a heat threshold and the lower-level service node that does not own the content exists among lower-level service nodes of the first service node.

It should be noted that if a certain piece of content does not exist on the service node, the times of service scheduling requests for the content sent by the terminal will still be counted after a service scheduling request for the content sent by the terminal is received, and a current heat value of the content is determined according to a statistical result. The determining mode is similar to step 403. The difference is that the initial heat value of the content is 0. When the current heat value of the content reaches the heat threshold, the service node sends the request message to its upper-level service node or the control node, so as to request the upper-level service node or the control node to provide the content. If the upper-level service node is requested, when the upper-level service node has the content, it directly delivers the content to the service node; when the upper-level service node does not have the content, it may continue to request its upper-level service node for the content, and record a mapping relationship between the content and the service node that requests the content; if the content sent by the upper-level service node is received, it directly sends the content to the service node according to the mapping relationship. If the control node is requested, after the control node receives the request message, it may request the content from an external content supply source.

It should be noted that each service node in each of the preceding embodiments regularly reports a node status report to the control node, where the node status report includes: the number of terminals currently served by the service node, a list of content on the service node, a current heat value of each piece of content on the service node, and so on.

After receiving a node status report reported by each service node, the control node stores the number of terminals currently served by each service node, a list of content, a current heat value of each piece of content on each service node, and so on. In addition, the number of terminals currently served by a service node is compared with the maximum number of terminals allowed to be served by the service node, and when a difference between the number of terminals currently served by the service node and the maximum number of terminals allowed to be served by the service node is greater than a threshold value, a heat threshold of the service node is lowered. When the difference between the number of terminals currently served by the service node and the maximum number of terminals allowed to be served by the service node is greater than the threshold, it indicates that the number of terminals currently served by the service node is smaller, and the service node may further serve more terminals. In order to serve more terminals, the heat threshold of the service node is lowered. In this way, a current heat value for a certain piece of content on the service node easily reaches the heat threshold.

Therefore, the service node may request content from its upper-level service node or the control node, so as to serve more terminals subsequently. The control node may further adjust a service capability of each service node, that is, adjust the maximum number of terminals allowed to be served by each service node.

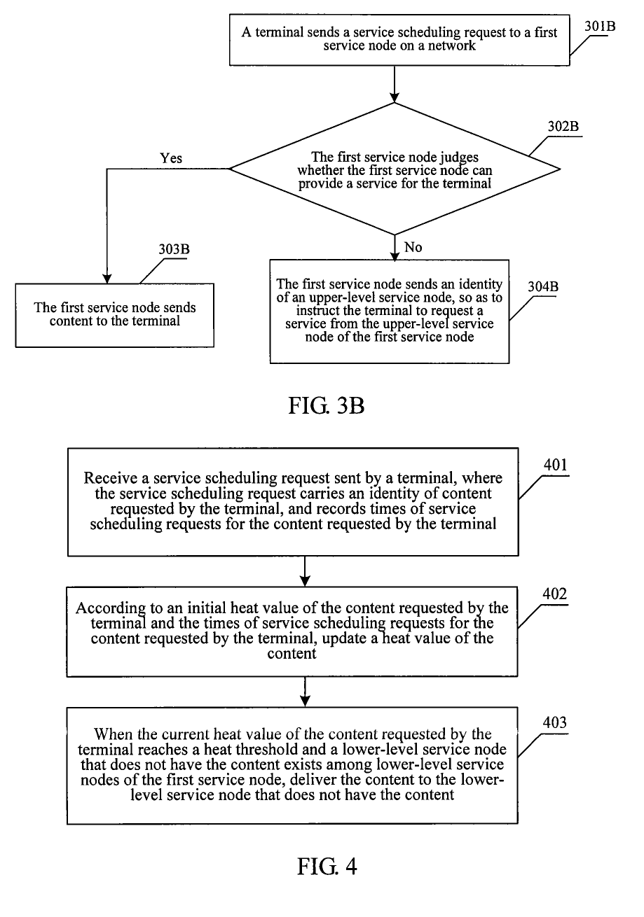

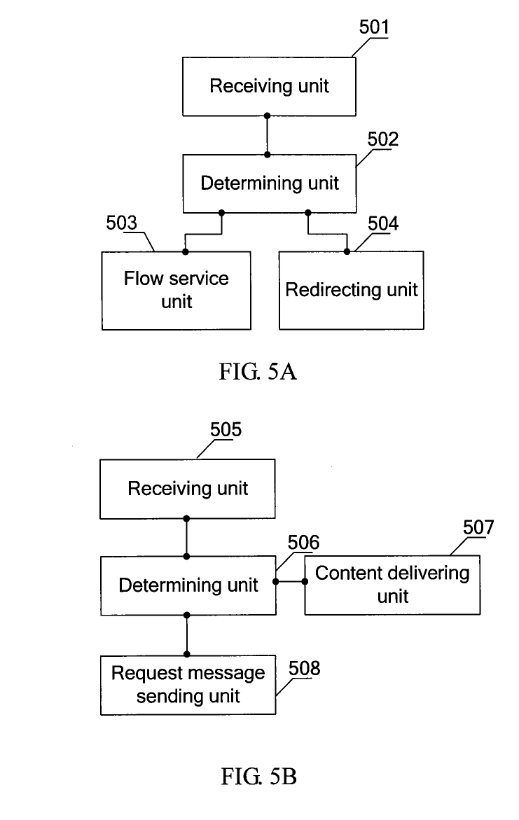

FIG. 5A shows a structure of a service node provided in an embodiment of the present invention. The service node includes:

a receiving unit 501, configured to receive a service scheduling request sent by a terminal; and

a determining unit 502, configured to determine an available service node according to indication information that is sent by a control node and indicates an upper/lower-level relationship of the service node on the CDN and according to content requested by the terminal; where the available service node is configured to provide the requested content for the terminal.

The determining unit 502 is specifically configured to determine, according to the indication information that is sent by the control node and indicates the upper/lower-level relationship of the service node on the CDN, that the service node does not have lower-level service nodes, and when determining, according to the content requested by the terminal, that the service node has the content requested by the terminal, determine that the service node is an available service node.

When a maximum number of terminals allowed to be served is set for the service node, the determining unit is further configured to: before determining that the service node is an available service node, determine that a number of terminals currently served by the service node does not reach the maximum number of terminals allowed to be served.

The determining unit is further configured to: when determining, according to the indication information that is sent by the control node and indicates the upper/lower-level relationship of the service node on the CDN, that the service node does not have lower-level service nodes but has upper-level service nodes, determining, according to the content requested by the terminal, that the service node has the content requested by the terminal, and determining that the number of terminals currently served by the service node reaches the maximum number of terminals allowed to be served, determine that an upper-level service node of the service node determines an available service node; or the determining unit is further configured to: when determining, according to the indication information that is sent by the control node and indicates the upper/lower-level relationship of the service node on the CDN, that the service node does not have lower-level service nodes but has upper-level service nodes, and determining, according to the content requested by the terminal, that the first service node does not have the content requested by the terminal, determine that an upper-level service node of the first service node determines an available service node.

The determining unit is further configured to: when determining, according to the indication information that is sent by the control node and indicates the upper/lower-level relationship of the service node on the CDN, that the service node has lower-level service nodes and has upper-level service nodes, and determining, according to the content requested by the terminal, that the service node and all lower-level service nodes of the service node do not have the content requested by the terminal, determine that an upper-level service node of the service node determines an available service node; or the determining unit is further configured to: when determining, according to the indication information that is sent by the control node and indicates the upper/lower-level relationship of the service node on the CDN, that the service node has lower-level service nodes and has upper-level service nodes, but determining, according to the content requested by the terminal, that the number of terminals currently served by a service node that owns the content requested by the terminal reaches the maximum number of terminals allowed to be served, determine that an upper-level service node of the first service node determines an available service node, where the service node that owns the content requested by the terminal includes a service node that receives the service scheduling request sent by the terminal or a lower-level service node of the service node that receives the service scheduling request sent by the terminal.

The service node further includes:

a flow serving unit 503, configured to: when the determined available service node is the service node, provide the requested content for the terminal; and

a redirecting unit 504, configured to: when the determined available service node is an upper-level service node of the service node, send an identity of the upper-level service node of the first service node to the terminal so that the terminal requests content from the upper-level service node of the first service node.

Alternatively, the receiving unit 501 is further configured to receive an updated service scheduling request sent by the terminal, where the updated service scheduling request includes the content requested by the terminal and identities of service nodes that have already been requested; the determining unit 502 is further configured to determine that the updated service scheduling request carries the identity of the service node that has been requested, and determine an available service node according to the content requested by the terminal and a position of the terminal, specifically, determine, among the service node and all lower-level service nodes managed by the service node except the service nodes that have already been requested, a service node that has the content requested by the terminal and has a smallest distance from the terminal as the available service node.

FIG. 5A shows the structure of the service node provided in the embodiment of the present invention. The service node that is configured to adjust delivered content further includes:

a receiving unit 505, configured to receive a service scheduling request sent by a terminal, where the service scheduling request carries an identity of content requested by the terminal, and records times of service scheduling requests for the content requested by the terminal;

a determining unit 506, configured to determine a current heat value of the content requested by the terminal according to an initial heat value of the content requested by the terminal and the times of service scheduling requests for the content; and

a content delivering unit 507, configured to deliver the content to a lower-level service node that does not own the content when the current heat value of the content requested by the terminal reaches a heat threshold, and the lower-level service node that does not own the content exists among lower-level service nodes of the first service node,

In addition, the determining unit 506 in the service node provided in this embodiment is further configured to determine, according to the indication information that is sent by the control node and indicates the upper/lower-level relationship of the service node on the CDN, that the service node has upper-level service nodes, determine, according to times of received service scheduling requests for the content that is not currently available by the service node, a current heat value of the content that is not currently available, and judge that the current heat value of the content that is not currently available reaches a preset heat threshold; the service node further includes: a request message sending unit 508, configured to send a request message to an upper-level service node of the service node or to the control node, where the request message is used to request the upper-level service node of the service node or the control node to provide the content that is not currently available.

In addition, the functions of the service node provided in FIG. 5A may be combined with the functions of the service node provided in FIG. 5B. For specific implementation of the functions of the service nodes provided in FIG. 5A and FIG. 5B, reference may be made to the description in the preceding method embodiments, which is not described in detail herein.

Any one service node provided in this embodiment of the present invention can directly receive a service scheduling request sent by a terminal, and determine an available service node according to indication information that is sent by a control node and indicates an upper/lower-level relationship of the service node on a CDN and content requested by the terminal. Therefore, one service node (that is, a central node in the prior art) does not need to process all service scheduling requests of all terminals, thereby reducing a service processing load of the central node and making service processing more flexible; and furthermore, when receiving a service scheduling request sent by a terminal, an edge node may directly send content requested by the terminal to the terminal, and in this way, the speed of service processing can be improved, waiting time of the terminal can be reduced, and user experience can be improved.

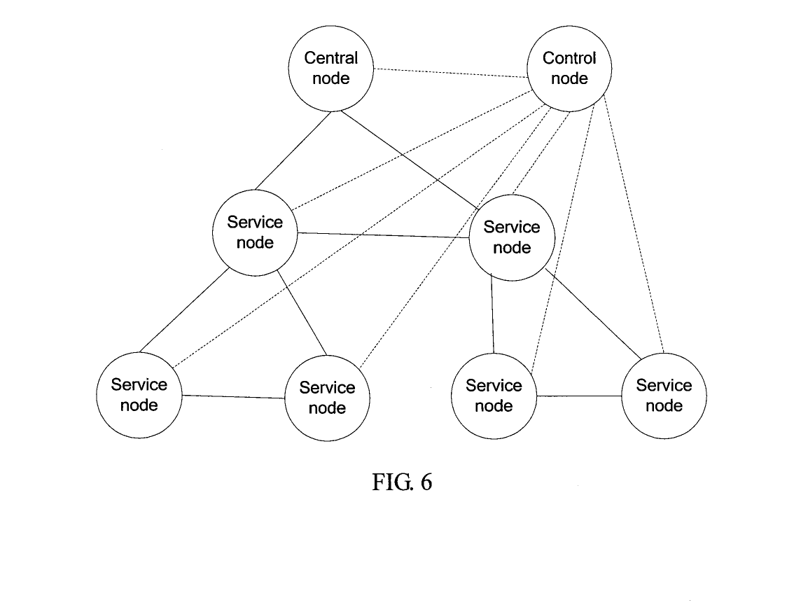

Referring to FIG. 6, an embodiment of the present invention provides a content delivery network, which includes a central node, service nodes, and a control node. For a function and a structure of each service node, reference may be made to a corresponding description in the embodiment shown in FIG. 5.

The functions implemented by the central node are the same as the functions that may be implemented by a central node in the prior art, and are not described herein.

The control node is further configured to manage all service nodes. Specifically, it may be configured to receive position information of a service node specified by a user on a CDN, where the service node is any one service node on the CDN, and the position information includes indication that indicates an upper/lower-level relationship between the service node and other service nodes, and send the position information to the service node; further, it is configured to receive a node status report submitted by the service node, where the node status report includes a number of terminals currently served by the service node, type and size of each piece of content on the service node, a current heat value of each piece of content on the service node, and so on, compare the number of terminals currently served by the service node and a maximum number of terminals allowed to be served according to the node status report submitted by the service node, and send indication information for lowering a heat threshold on the service node when a difference between the number of terminals currently served by the service node and the maximum number of terminals allowed to be served by the service node is greater than a threshold value. In this manner, the current heat value of a certain piece of content on the service node easily reaches the heat threshold. Therefore, the service node may request the content from its upper-level service nodes or control node so as to provide service for more terminals subsequently. Further, the service capability of each service node may be adjusted, that is, the maximum number of terminals allowed to be served by each service node may be adjusted. Further, content distribution on the service node may be controlled according to the node status report of each node. For example, when the current heat value of a certain piece of content is low, the service node may be notified to delete the stored content.

On the CDN, each service node has a same basic structure. Therefore, each service node has the same content delivery capability and service scheduling processing capability. The executed functions may be different as the position of each service node on the network is different. In the network system, each service node may be directly connected to the control node, allowing the control node to easily manage the service nodes; or multiple service nodes may form a tree-shape structure, where service nodes at a same layer may be connected, facilitating application of P2P technology.

The control node on the content delivery network provided in this embodiment of the present invention manages each service node in a unified manner. Each service node has the same content delivery capability and service scheduling processing capability but they execute different operations because they are located at different positions. This may facilitate extension and maintenance of a network on a service node, and can reduce dependency of the service node on the control node. Even if a connection between a service node and the control node is disconnected, the service node may still receive a service scheduling request of a terminal, and perform corresponding processing.

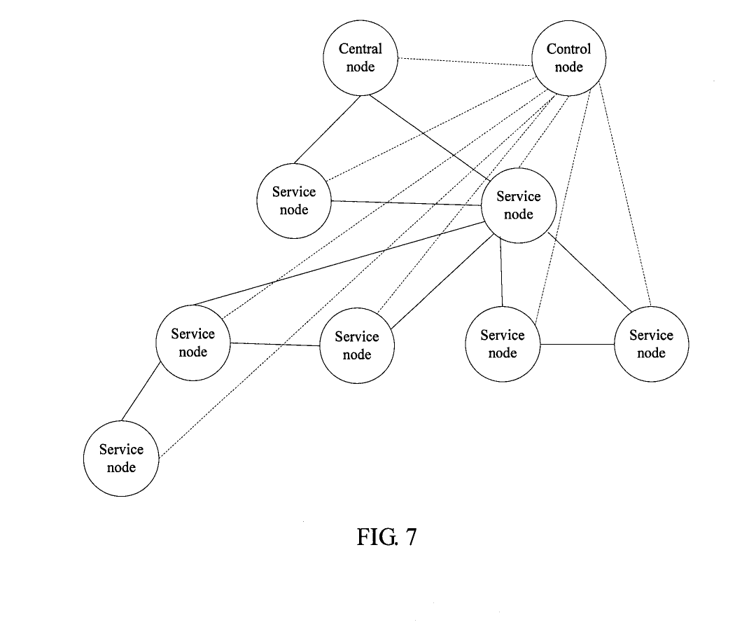

Because the preceding CDN is adopted, a position of a service node on the CDN may be adjusted randomly. It is assumed that a network topology structure before adjustment is shown in FIG. 7, and a network topology structure after adjustment is shown in FIG. 7. Compared with the structure in FIG. 6, in the structure in FIG. 7, a layer of service node is added, and a subordinate relationship of a service node at a third layer is also changed from the left side at a second layer to the right side of the second layer. Specifically, after a control node receives an instruction for adjusting a service node position, network topology information of an entire network after adjustment may be sent to each service node, or a service node may be notified of only a change to its subordinate relationship.

The service nodes provided in this embodiment may be various terminals, such as mobile phones, computers, and fixed phone terminals, or may also be servers. The functions implemented by the service nodes may be executed by processors in the terminals or servers.

A person skilled in the art should understand that all or part of the steps of the method according to the preceding embodiments may be implemented by a program instructing relevant hardware. The program may be stored in a computer readable storage medium, such as a read-only memory, a magnetic disk, or a compact disk.

The service processing method, method for adjusting delivered content, service node, and content delivery network that are provided in the embodiments of the present invention are described in detail in the preceding. A principle and implementation manner of the present invention are described by using specific examples in this specification. The descriptions of the preceding embodiments are only used to help understand the method and core ideas of the present invention; and meanwhile, persons skilled in the art may make variations to the specific implementation manner and application scope according to the idea of the present invention. In conclusion, the content of this specification shall not be construed as a limitation to the present invention.

What is claimed is:

1. A service processing method, comprising:
receiving, by a first service node, a service scheduling request sent by a terminal, wherein the first service node is any one service node except a central node on a content delivery network (CDN);
determining, by the first service node, an available service node according to indication information that is sent by a control node and indicates an upper/lower-level relationship of the first service node on the CDN and according to content requested by the terminal; and
providing, by the available service node, the requested content to the terminal.

2. The method according to claim 1, wherein the determining, by the first service node, an available service node according to indication information that is sent by a control node and indicates an upper/lower-level relationship of the first service node on the CDN and according to content requested by the terminal specifically comprises:
when the first service node determines, according to indication information that is sent by a control node and indicates an upper/lower-level relationship of the first service node on the CDN, that the first service node does not have lower-level service nodes, and determines, according to the content requested by the terminal, that the first service node has the content requested by the terminal, determining that the first service node is an available service node.

3. The method according to claim 2, comprising:
before determining that the first service node is an available service node, the method further comprises:
determining, by the first service node, that a number of terminals currently served by the first service node does not reach a maximum number of terminals allowed to be served.

4. The method according to claim 1, wherein:
determining, by the first service node, an available service node according to the indication information that is sent by a control node and indicates an upper/lower-level relationship of the first service node on the CDN and according to content requested by the terminal specifically comprises:
when the first service node determines, according to the indication information that is sent by the control node and indicates the upper/lower-level relationship of the first service node on the CDN, that the first service node has no lower-level service node but has an upper-level service node, and determines, according to the content requested by the terminal, that the first service node does not has the content requested by the terminal, determining that the upper-level service node of the first service node determines an available service node; or when the first service node determines, according to the indication information that is sent by the control node and indicates the upper/lower-level relationship of the first service node on the CDN, that the first service node has no lower-level service node but has an upper-level service node, determines, according to the content requested by the terminal, that the first service node has the content requested by the terminal, and determines that the number of terminals currently served by the first service node reaches the maximum number of terminals allowed to be served, determining that the upper-level service node of the first service node determines an available service node; and
the method further comprises: sending an identity of the upper-level service node of the first service node to the terminal so that the terminal requests content from the upper-level service node of the first service node.

5. The method according to claim 1, wherein:
determining, by the first service node, an available service node according to the indication information that is sent by a control node and indicates an upper/lower-level relationship of the first service node on the CDN and according to content requested by the terminal specifically comprises:
when the first service node determines, according to the indication information that is sent by the control node and indicates the upper/lower-level relationship of the first service node on the CDN, that the first service node has lower-level service nodes and upper-level service nodes, and determines, according to the content requested by the terminal, that the first service node and all lower-level service nodes of the first service node do not have the content requested by the terminal, determining that an upper-level service node of the first service node determines an available service node; or when the first service node determines, according to the indication information that is sent by the control node and indicates the upper/lower-level relationship of the first service node on the CDN, that the first service node has lower-level service nodes and upper-level service nodes, but determines, according to the content requested by the terminal, that a number of terminals currently served by a service node that owns the content requested by the terminal reaches a maximum number of terminals allowed to be served, determining that an upper-level service node of the first service node determines an available service node, wherein the service node that owns the content requested by the terminal comprises the first service node or the lower-level service node of the first service node; and
the method further comprises: sending an identity of the upper-level service node of the first service node to the terminal, so that the terminal requests content from the upper-level service node of the first service node.

6. The method according to claim 5, wherein the determining, by the upper-level service node of the first service node, an available service node specifically comprises:
receiving, by the upper-level service node of the first service node, an updated service scheduling request sent by the terminal, wherein the updated service scheduling request comprises the content requested by the terminal and an identity of the first service node that has already been requested; and
determining, by the upper-level service node of the first service node, that the updated service scheduling request carries the identity of the first service node, and determining an available service node according to the content requested by the terminal and a position of the terminal.

7. The method according to claim 4, wherein the determining, by the upper-level service node of the first service node, an available service node specifically comprises:
receiving, by the upper-level service node of the first service node, an updated service scheduling request sent by the terminal, wherein the updated service scheduling request comprises the content requested by the terminal and an identity of the first service node that has already been requested; and
determining, by the upper-level service node of the first service node, that the updated service scheduling request carries the identity of the first service node, and determining an available service node according to the content requested by the terminal and a position of the terminal.

8. The method according to claim 6, wherein determining an available service node according to the content requested by the terminal and a position of the terminal specifically comprises:
determining, by the upper-level service node of the first service node, among the upper-level service node of the first service node and all lower-level service nodes managed by it except the first service node, a service node that owns the content requested by the terminal and has a smallest distance from the terminal as the available service node.

9. The method according to claim 8, wherein determining an available service node according to the content requested by the terminal and a position of the terminal specifically comprises:
determining, by the upper-level service node of the first service node, among the upper-level service node of the first service node and all lower-level service nodes managed by it except the first service node, a service node that owns the content requested by the terminal and has a smallest distance from the terminal as the available service node.

10. A service node, wherein the service node is any one service node except a central node on a content delivery network (CDN), and the service node comprises:
a receiving unit, configured to receive a service scheduling request sent by a terminal; and
a determining unit, configured to determine an available service node according to indication information that is sent by a control node and indicates an upper/lower-level relationship of the service node on the CDN and according to content requested by the terminal;
wherein the available service node is configured to provide the requested content for the terminal.

11. The service node according to claim 10, wherein:
the determining unit is specifically configured to:
determine, according to the indication information that is sent by the control node and indicates the upper/lower-level relationship of the service node on the CDN, that the service node does not have lower-level service nodes, and when determining, according to the content requested by the terminal, that the service node has the content requested by the terminal, determine that the service node is an available service node.

12. The service node according to claim 11, wherein:
the determining unit is further configured to: before determining that the service node is an available service node, determine that a number of terminals currently served by the service node does not reach a maximum number of terminals allowed to be served.

13. The service node according to claim 10, wherein:
the determining unit is specifically configured to: when determining, according to the indication information that is sent by the control node and indicates the upper/lower-level relationship of the service node on the CDN, that the service node does not have lower-level service nodes but has upper-level service nodes, determining, according to the content requested by the terminal, that the service node has the content requested by the terminal, and determining that the number of terminals currently served by the service node reaches the maximum number of terminals allowed to be served, determine that an upper-level service node of the service node determines an available service node; or the determining unit is further configured to: when determining, according to the indication information that is sent by the control node and indicates the upper/lower-level relationship of the service node on the CDN, that the service node does not have lower-level service nodes but has upper-level service nodes, and determining, according to the content requested by the terminal, that the first service node does not have the content requested by the terminal, determine that an upper-level service node of the first service node determines an available service node; and
the service node further comprises a redirecting unit, configured to send an identity of an upper-level service node of the service node to the terminal so that the terminal requests content from the upper-level service node of the service node.

14. The service node according to claim 10, wherein:
the determining unit is specifically configured to: when determining, according to the indication information that is sent by the control node and indicates the upper/lower-level relationship of the service node on the CDN, that the service node has lower-level service nodes and has upper-level service nodes, and determining, according to the content requested by the terminal, that the service node and all lower-level service nodes of the service node do not have the content requested by the terminal, determine that an upper-level service node of the service node determines an available service node; or the determining unit is further configured to: when determining, according to the indication information that is sent by the control node and indicates the upper/lower-level relationship of the service node on the CDN, that the service node has lower-level service nodes and has upper-level service nodes, but determining, according to the content requested by the terminal, that the number of terminals currently served by a service node that owns the content requested by the terminal reaches the maximum number of terminals allowed to be served, determine that an upper-level service node of the first service node determines an available service node, where the service node that owns the content requested by the terminal includes a service node that receives the service scheduling request sent by the terminal or a lower-level service node of the service node that receives the service scheduling request sent by the terminal; and
the service node further comprises a redirecting unit, configured to send an identity of an upper-level service node of the service node to the terminal so that the terminal requests content from the upper-level service node of the service node.

15. The service node according to claim 14, wherein:
the receiving unit is further configured to receive an updated service scheduling request sent by the terminal, wherein the updated service scheduling request comprises the content requested by the terminal and identities of service nodes that have already been requested; and
the determining unit is further configured to determine that the updated service scheduling request carries the identities of the service nodes that have already been requested, and determine an available service node according to the content requested by the terminal and a position of the terminal.

16. The service node according to claim 15, wherein:
determining, by the determining unit, an available service node according to the content requested by the terminal and a position of the terminal specifically comprises: determining, among the service node and all lower-level service nodes managed by the service node except the service nodes that have already been requested, a service node that has the content requested by the terminal and has a smallest distance from the terminal as the available service node.

17. A service node, comprising:
a receiving unit, configured to receive a service scheduling request sent by a terminal, wherein the service scheduling request carries an identity of content requested by the terminal, and records times of service scheduling requests for the content requested by the terminal;
a determining unit, configured to determine a current heat value of the content requested by the terminal according to an initial heat value of the content requested by the terminal and the times of service scheduling requests for the content; and
a content delivering unit, configured to deliver the content to a lower-level service node that does not own the content when the current heat value of the content requested by the terminal reaches a heat threshold, and the lower-level service node that does not own the content exists among lower-level service nodes of the first service node.

18. The service node according to claim 17, wherein:
the determining unit is further configured to determine, according to the indication information that is sent by the control node and indicates a upper/lower-level relationship of the service node on a content delivery network (CDN), that the service node has upper-level service nodes, determine, according to times of received service scheduling requests for the content that is not currently available by the service node, a current heat value of the content that is not currently available, and judge that the current heat value of the content that is not currently available reaches a preset heat threshold; and
the service node further comprises:
a request message sending unit, configured to send a request message to an upper-level service node of the service node or to the control node, wherein the request message is configured to request the upper-level service node of the service node or the control node to provide the content that is not currently available.
